(19) United States
(12) Patent Application Publication
(10) Pub. No.: US 2026/0111526 A1
(43) Pub. Date: Apr. 23, 2026

(54) STRONG HEADLESS AUTHENTICATION WITHOUT USER INVOLVEMENT

(71) Applicant: Palo Alto Networks, Inc., Santa Clara, CA (US)

(72) Inventors: Natan Shaltiel, Kiryat Ono (IL); Meitar Naveh, Tel Aviv (IL); Guy Bar On, Brookline, MA (US); Ofer Ben-Noon, Tel Aviv (IL)

(21) Appl. No.: 18/922,832

(22) Filed: Oct. 22, 2024

(51) Int. Cl. G06F 21/41

(52) U.S. Cl. CPC G06F 21/41

(57) ABSTRACT

A service installed on a user's device identifies a user that has logged into an account associated with an organization that has provided the service for installment. When the service determines that the user has successfully authenticated with an identity provider used by the organization, the service determines information about the session with the identity provider that was created to strongly authenticate the user. The service sends an authentication request to the identity provider as part of the same session with the identity provider that was created when the user was strongly authenticated. The authentication request generated by the service includes a parameter value for configuring authentication without user involvement, such as a parameter value for configuring passive or no prompt authentication. The user thus can be strongly authenticated to the service.

### BACKGROUND

The disclosure generally relates to data processing (e.g., CPC subclass G06F) and to authentication (e.g., CPC subclass G06F 21/30).

“Headless authentication” refers to authentication in headless computing environments. Headless computing environments refer to those in which the front-end system operates without a graphical user interface (GUI), such as is the case for headless web browsers or other headless software, and/or in which the front-end and backend systems are decoupled and operate independently of each other. During headless authentication, a front-end (i.e., client-side) system can interact with a backend system via an application programming interface (API) exposed by the backend system. Headless authentication of users is often token-based, where the backend system generates tokens for users that have supplied valid credentials and provides these tokens to the front-end system for inclusion in subsequent API requests corresponding to the authenticated user. Fulfillment of API requests is thus based on the backend system validating the tokens supplied therewith.

Single sign-on (SSO) is an authentication process that allows users to log in to multiple applications or services with a single set of credentials. An identity provider (IdP) is a service that manages user identity information and performs authentication on behalf of the user. When a user attempts to access a service (the “service provider”) via SSO, the service provider redirects the user to the IdP for authentication. After verifying the user's credentials, the IdP sends an authentication token to the service provider, granting the user access without requiring additional logins.

### BRIEF DESCRIPTION OF THE DRAWINGS

Embodiments of the disclosure may be better understood by referencing the accompanying drawings.

FIG. 1 is a conceptual diagram of headless authentication of users without user involvement.

FIG. 2 is a flowchart of example operations for installing and setting up an authentication service for authentication of users without user involvement.

FIG. 3 is a flowchart of example operations for identifying a user that is to be strongly authenticated to a service installed on the user's device.

FIG. 4 is a flowchart of example operations for strongly authenticating a user to a service installed on the user's device without user involvement.

FIG. 5 depicts an example computer system with a user authentication service.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Services that facilitate identity-based policy enforcement or telemetry collection for individual users can be implemented as agents or browser extensions installed on the users'devices. It is desirable that users be authenticated to these services with strong authentication to ensure that identity-based policy(ies) are correctly enforced for the user as well as to reduce the potential that users are impersonated (e.g., via credential theft). However, implementing strong authentication of users to such services can introduce friction in the users'experience due to repeated prompting of users to provide information for authentication (e.g., credentials, biometrics, etc.). Requests for authentication information may thus be ignored by users.

Techniques for strong, headless authentication of users in without user involvement as disclosed herein resolve the aforementioned challenges. A service installed on a user's device (e.g., as an agent or browser extension) identifies a user that has logged into an account associated with an organization that has provided the service for installment. When the service determines that the user has successfully authenticated with an identity provider used by the organization (generally with strong authentication), the service determines information about the session with the identity provider that was created to strongly authenticate the user. The service then requests the identity provider to authenticate the user without involvement of the user by sending an authentication request as part of the same session with the identity provider created when the user was strongly authenticated. The authentication request generated by the service includes a parameter value for configuring authentication without user involvement, such as a parameter value for configuring passive or no prompt authentication. The user thus can be strongly authenticated to the service because the service orchestrates authentication of the user during the same session that was created for prior strong authentication of the user. The service can then enforce identity-based policies for the user, collect telemetry data attributable to the user directly, or perform other actions that are specific for the user that has been strongly authenticated.

### Example Illustrations

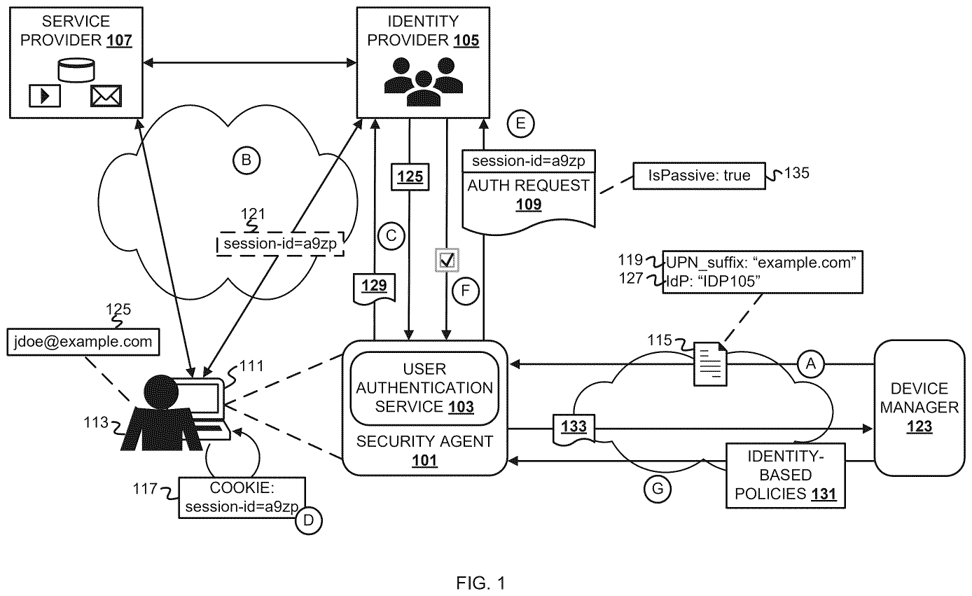

FIG. 1 is a conceptual diagram of headless authentication of users without user involvement. FIG. 1 depicts a security agent 101 executing on a device 111 that has been issued to a user 113. The security agent 101 may have been installed on the device 111 prior to issuance of the device 111 to the user 113 or may have been deployed to the device 111 by an organization that owns/manages the device 111 (hereinafter “the organization” for brevity), such as an employer of the user 113. When the security agent 101 is deployed, the security agent 101 includes a configuration with parameters for identifying an identity provider used by the organization for strong authentication (depicted in FIG. 1 as an identity provider 105). The security agent 101 provides various security functionalities for the organization, such as enforcing identity-based policies based on user activity detected on the device 111 and/or reporting telemetry data collected for the device 111 to the organization, among other examples. The service with which the security agent 101 can communicate for obtaining the identity-based policies, reporting telemetry data, etc. is depicted in FIG. 1 as device manager 123. The device manager 123 can execute on a service associated with the organization, as a cloud-based service offered by the organization, etc. For instance, the security agent 101 can be deployed for communication with the device manager 123 for mobile device management (MDM) implemented via the device manager 123.

FIG. 1 also depicts a service provider 107 and an identity provider 105. The service provider 107 offers services and resources to users having accounts therewith, such as email services, messaging services, etc. The service provider 107 may provide SSO services. Users such as the user 113 are assumed to have accounts with the service provider 107 set up by the organization. The identity provider 105 authenticates users logging into their accounts with the service provider 107 (e.g., as part of SSO). The identity provider 105 may be a third-party or enterprise identity provider employed by the organization for authentication of users signing into the service provider 107. In other examples, the identity provider 105 and the service provider 107 may be different services offered by an enterprise that provides various identity and access management services (e.g., the Google Cloud™ enterprise services for identity and access management, the Microsoft Entra® identity and access manager, etc.). When users attempt to login to their accounts with the service provider 107, the service provider 107 redirects users to the identity provider 105 for completion of authentication, and the service provider 107 grants users access to service and resources thereof based on successful authentication by the identity provider 105.

A user authentication service (“authentication service”) 103 executes as part of the security agent 101. The authentication service 103 authenticates users of devices on which it executes to respective instances of the security agent 101 with strong authentication and without involvement of the user. In other words, users do not supply credentials to the authentication service 103 directly (e.g., via user input) as part of authenticating to the security agent 101. Authentication of users by the authentication service 103 can be considered headless because the authentication service 103 and the identity provider 105 operate independently of each other and/or because the security agent 101 does not necessarily comprise a GUI.

FIG. 1 is annotated with a series of letters A-G. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the security agent 101 obtains an agent configuration 115 from the device manager 123. The security agent 101 can obtain the agent configuration 115 as part of device 111 setup and initial configuration by the user 113, for instance. The device manager 123 can push (i.e., communicate) the agent configuration 115 to the device 111 over a secure communication connection established therebetween. The agent configuration 115 comprises configuration information that facilitates authentication of users to the security agent 101, which at least includes a user principal name (UPN) suffix 119 of the organization and indicates the identity provider 105. The UPN suffix 119 is a domain name included in user identities associated with the organization, depicted in this example as “example.com”. As described further below, users authenticated to the security agent 101 should be associated with the UPN suffix 119. Since the security agent 101 can be compatible with a plurality of identity providers, the agent configuration identifies an identity provider that will be employed for user authentication by a user of the device 111, which in this example is the identity provider 105.

At stage B, the user 113 logs into their account with the service provider 107 based on successful authentication by the identity provider 105. The user 113 has a user identifier 125 associated with the respective account with the service provider 107, depicted in this example as “jdoe@example.com”, and the user 113 provides this user identifier 125 to the identity provider as part of authentication by the identity provider 105. As part of supplying credentials to the identity provider 105, a session 121 is established between the device 111 and the identity provider 105, depicted as having a session identifier of “a9zp” in this example. The flow of communications among the device 111, service provider 107, and identity provider 105 for authentication of the user 113 and establishment of a login session are known in the art and are not depicted in additional detail in FIG. 1 for brevity. This example assumes that the user 113 is successfully authenticated and logged into their account with the service provider 107, though the same flow of operations described herein is supported when users authenticate directly with the identity provider 105 and no external service provider such as the service provider 107 is involved.

At stage C, the authentication service 103 identifies a user that logged into a session with the service provider 107 on the device 111 (e.g., via a web browser). The authentication service 103 determines an identity of the user associated with the login session to identify the user. Determination of the user identity associated with the login session is generally dependent on the identity provider being utilized for user authentication, as different identity providers may store or make available user identities associated with login sessions differently. In this example, the authentication service 103 determines the user identifier 125 based on submission of a request 129 to the identity provider 105, such as via an application programming interface (API) of the identity provider 105. The authentication service 103 retrieves the user identifier 125 in response to the request 129.

In this example, the authentication service 103 also verifies that the user identifier 125 is associated with the organization for which the UPN suffix 119 indicated in the agent configuration 115 is registered by determining if the user identifier 125 comprises the UPN suffix 119. Since the user identifier 125 does include the UPN suffix 119 in this example, the authentication service 103 proceeds with authenticating the user 113 to the security agent 101. This check can be performed to ensure that identity-based policy enforcement, telemetry data collection, etc. are later performed based on the user's activity while logged into an account associated with the organization (e.g., in contrast to a personal account), as consent for monitoring user activity granted by users to the organization may be limited to activities performed in the context of the organization.

At stage D, the authentication service 103 determines whether an active session with the identity provider 105 exists. The authentication service 103 determines whether a session between the device 111 (i.e., e.g., via a web browser installed on the device) and the identity provider 105 has been created. A session cookie or other session information identifying the session will be stored on the device 111 if a session with the identity provider 105 is active. The authentication service 103 has been preconfigured with a location of storage of session information for sessions with the identity provider 105, and this location in storage may also be dependent on the identity provider being used in implementations. Each identity provider with which the authentication service 103 is compatible has one or more predefined cookies that are accessible to the authentication service 103. For instance, the authentication service 103 can check a certain location in which the web browser executing on the device 111 stores session cookies. In this example, the authentication service 103 identifies a session cookie 117 stored by the web browser for the session 121. The session cookie 117 indicates the session identifier for the session 121, or “a9zp.” The session cookie 117 can also indicate metadata such as a time of creation of the session 121.

If an active session is identified, as is the case in this example, the authentication service 103 can determine if the session is sufficiently fresh. The authentication service 103 determines an age of the session 121, such as based on a timestamp associated with the session cookie 117, and evaluates the age to determine if the session is sufficiently fresh or if the session is stale, such as based on a threshold session age. The authentication service 103 proceeds with authentication of the user 113 if the session is sufficiently fresh (e.g., if the session age is below the threshold).

At stage E, the authentication service 103 generates an authentication request 109 that is modified to include a parameter value that is for configuring authentication without user involvement. The authentication service 103 generates the authentication request 109 to comport to an authentication standard or protocol used by the identity provider 105, such as Security Assertion Markup Language (SAML) for exchanging authentication information or OpenID Connect. This example assumes the identity provider 105 exchanges authentication information with SAML. The authentication service 103 incorporates in the authentication request 109 a parameter value 135 for configuring passive authentication, which is the “IsPassive” optional parameter used in SAML for configuring passive authentication. The authentication service 103 also includes in the authentication request 109 a parameter value indicating to the identity provider 105 that the user need not be re-authenticated, such as the SAML parameter “forceAuthn” set with a value of “false.” The authentication service 103 communicates the authentication request 109 to the identity provider 105 over the session 121 that has already been established with the identity provider 105. The authentication service 103 can do so as a result of identifying the session cookie 117 that indicated the session identifier of the session 121.

At stage F, the authentication service 103 completes the authentication flow with the identity provider 105 to authenticate the user 113. The authentication flow can depend on the standard or protocol used by the identity provider 105 for authentication. In this example, the identity provider 105 authenticates the user 113 and may respond to the authentication service 103 with a SAML assertion. This example assumes that authentication of the user 113 was successful.

At stage G, the security agent 101 notifies the device manager 123 that user authentication was successful. The security agent 101 sends the device manager 123 information 133 received from the identity provider 105 as a result of authenticating the user 113, such as a SAML assertion, that is validated by the device manager 123. If the device manager 123 validates the obtained information 133, the device manager 123 can identify the user 113., which can inform selection of identity-based policies that are applicable to the user 113 based on their identity. The device manager 123 responds to the security agent 101 with identity-based policies 131 that are applicable to the user 113. The security agent 101 can thus enforce the identity-based policies for the user 113 based on monitored activity during the login session with the service provider 107.

FIG. 1 depicts the authentication service 103 as executing as part of an agent (i.e., the security agent 101). In implementations, the authentication service 103 can execute as part of a browser extension or other service that can be deployed for MDM.

The browser extension or other service communicates with the device manager 123 to obtain a corresponding configuration indicating a UPN suffix and identity provider and authenticates a user of the device on which the browser extension or other service executes as similarly described above. The browser extension or other service may not comprise a GUI (e.g., may be a headless web browser).

FIG. 1 depicts an example of the authentication service 103 authenticating a user with strong, headless authentication without involving the user based on communications among a device, a service provider, and an identity provider. Other examples for headless authentication are possible, however. For instance, the authentication service 103 can execute a script that extracts an identity of the user (e.g., username) from the device 111 along with a certificate previously installed on the device 111. The authentication service 103 providers the user identity and the extracted certificate from the device 111 to the agent 101, which redirects to a dedicated authentication service that validates the user identity and the certificate to issue an authentication token. As another example, the authentication service 103 can establish a trusted connection to another authentication application, such as an enterprise browser or a dedicated agent, and request issuance of a token from the authentication application. Headless authentication may also be driven based on the authentication service 103 initially redirecting users to the organization's identity provider before web access is granted and before any sign-on attempts by the user are made, so users authenticate one time before gaining web access. If credentials for strong authentication are stored on the user's device, the authentication service 103 may utilize these credentials to authenticate the user to the security agent 101 after the user has been authenticated by the identity provider 105. Lastly, if a user being authenticated has multiple devices issued thereto, the authentication service 103 can implement an authentication token or cookie from another device issued to the user for user authentication.

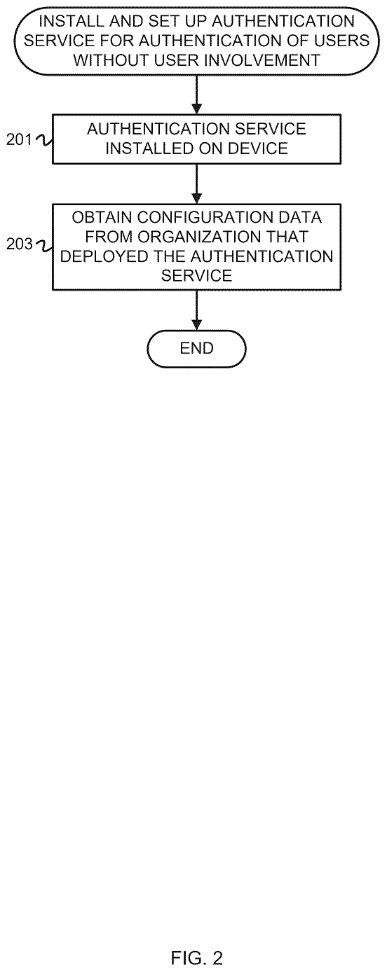

FIGS. 2-4 are flowcharts of example operations. The example operations are described with reference to a user authentication service (hereinafter “the authentication service”) for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for installing and setting up an authentication service for authentication of users without user involvement. The authentication service is deployed by an organization that employs a service executing on end users'devices (e.g., a browser extension or agent), which may execute as headless software, to which users will authenticate via the authentication service. For instance, the service may be offered by a cybersecurity provider that provides cybersecurity services for the organization. The example operations refer to one device but can be performed across a plurality of devices owned or managed by the organization.

At block 201, the authentication service is installed on a device. The authentication service can execute as part of the service to which users will be authenticated via the authentication service such that the authentication service is installed when the service is installed. For instance, the authentication service can be installed based on deployment of an agent to the device for installation on the device, based on installation of a browser extension on the device, etc. Installation of the authentication device can be performed as part of initial device setup, such as based on issuance of the device to an end user (e.g., by the organization).

At block 203, the authentication service obtains configuration data from the organization that deployed the authentication service. The service that comprises the authentication service should be able to communicate with a backend service(s) of the organization, such as a cloud-based service, over a secure communication connection. The configuration data is provided to the device over the secure communication connection and installed on the device for access by the authentication service. The configuration data at least indicate an identity provider to which users should be authenticated and an account name (e.g., a UPN suffix) associated with the organization.

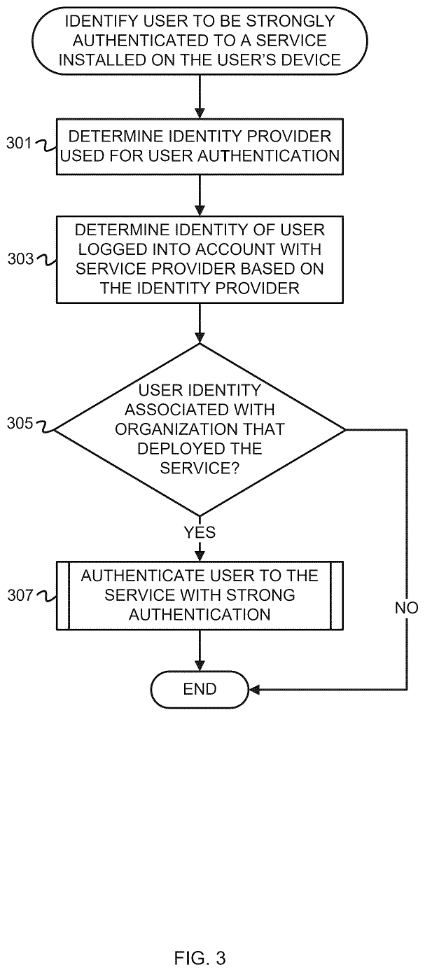

FIG. 3 is a flowchart of example operations for identifying a user that is to be strongly authenticated to a service installed on the user's device. The service refers to an agent, browser extension, or other software to which the authentication service authenticates the user without the user's involvement.

At block 301, the authentication service determines the identity provider used for user authentication. The identity provider to be used for user authentication and any applicable parameter values or settings are indicated in a configuration previously obtained by the authentication service.

At block 303, the authentication service determines an identity of the user logged into an account with a service provider based on the identity provider. For instance, the user may have logged into the account via SSO. The identity of the user can be a username that includes a UPN, such as an email address or other account name. The manner in which the authentication service determines the user identity is generally dependent on the identity provider that authenticated the user as part of the login. Some identity providers can provide an API to which a request for the identity of the logged-in user can be submitted. For these identity providers, the authentication service submits a request to the API of the identity provider to determine the user identity associated with the login session based on a response to the request. Other identity providers can indicate the user identity in a user profile that is accessible to the authentication service. As another example, some identity providers can store user identity information in a specific cookie stored on the user's device. The authentication service has been configured with an indication of a location of this cookie, which has been previously determined (e.g., based on expert knowledge/prior experimentation). Other identity providers have undocumented APIs that have been discovered that the authentication service queries for the user identity. Other locations that can store user identity information from which the authentication service determines the user identity include registry keys, files, and tokens.

At block 305, the authentication service determines if the user identity is associated with the organization that deployed the service to which the authentication service authenticates the user. For instance, if the user identity is an email address, the authentication service can determine if the user identity is associated with the organization based on determining if the email address includes the UPN suffix of the organization that deployed the authentication service. The authentication service has previously obtained configuration data that indicates the UPN suffix of the organization. If the user identity is associated with the organization, operations continue at block 307. If not, operations are complete.

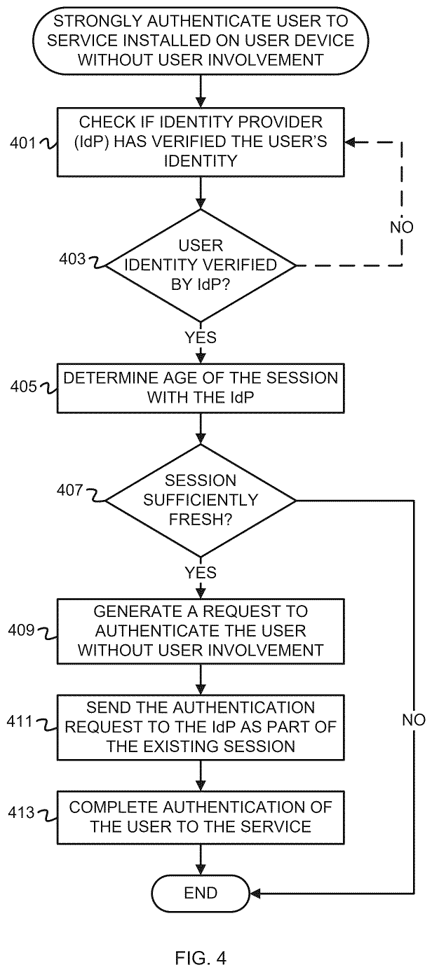

At block 307, the authentication service authenticates the user to the service with strong authentication. Authentication of the user to the service occurs without involvement of the user such that the user need not provide additional credentials for completing authentication to the service. Strong authentication of the user is described in further detail in reference to FIG. 4.

FIG. 4 is a flowchart of example operations for strongly authenticating a user to a service installed on the user's device without user involvement. The authentication service performs headless authentication of users without additional requests, prompts, etc. sent to the user (e.g., prompts for input of credentials).

At block 401, the authentication service checks if an identity provider has verified the user's identity. Whether the identity provider has verified the user's identity is informed by whether a session (e.g., a browser session) with the identity provider has been established. The authentication service determines if information for an active session has been stored for communications between a web browser of a device on which the authentication service executes and the identity provider. The particular location in which session information is stored can vary across identity providers, so the authentication service can check a certain location in storage (e.g., storage of the web browser) that stores session information such as session cookies. The location at which the session information for a session between the web browser and the identity provider (if any) is stored has been previously determined based on prior experimentation and/or expert knowledge.

At block 403, the authentication service determines if the user's identity has been verified by the identity provider. For instance, the authentication service determines if a session cookie or other session information was successfully identified and retrieved as a result of the check in the designated storage location. If the user's identity has been verified, operations continue at block 405. If not, operations continue back to block 401 for a subsequent check for whether the user's identity has been verified. The authentication service can perform checks for whether the user's identity has been verified periodically since new sessions may be created and/or may time out intermittently. As an illustrative example, the authentication service may perform this check every five minutes.

At block 405, the authentication service determines an age of the session with the identity provider. The age of the session is determined based on a timestamp associated with the session cookie or session information, based on metadata of the session cookie or session information indicating a time of creation of the session, etc.

At block 407, the authentication service determines if the session is sufficiently fresh. The authentication service maintains a freshness criterion indicating an age of sessions that is acceptable for proceeding with user authentication to prevent proceeding with user authentication in association with stale sessions. For instance, the freshness criterion can indicate a threshold of a 12 hour period, 24 hour period, etc. such that sessions are considered too stale after 12 hours, 24 hours, etc., respectively. If the session is sufficiently fresh, operations continue at block 409. Otherwise, operations are complete. The authentication service can later perform a new check for whether a new, fresh session has been created by repeating the operations performed at block 401. For instance, the authentication can perform this check periodically (e.g., every N minutes) or based on detecting a change in data or state, such as via detecting an update or other change to a session cookie.

At block 409, the authentication service generates a request to authenticate the user without user involvement. The authentication service generates the request to incorporate a parameter value for configuring authentication without involving the user. The parameter value incorporated in the request depends on the authentication standard or protocol used by the identity provider. For instance, the authentication service can generate a SAML authentication request having an “IsPassive” parameter with a value of “true” or an OpenID Connect authentication request having a “prompt” parameter with a value of “none.”

At block 411, the authentication service sends the authentication request to the identity provider as part of the existing session. The authentication service leverages the session cookie/session information identified at block 401 to send the authentication request as part of that same session over which the user was previously strongly authenticated by the identity provider. Subsequent example operations assume that authentication is successful, as authentication should be successful unless there is an error in processing the authentication request by the identity provider (e.g., due to server maintenance, server overload, etc.).

At block 413, the authentication service completes authentication of the user to the service. User authentication can proceed according to an authentication standard or protocol used by the identity provider. The user is authenticated to the service once the authentication flow between the authentication service and the identity provider has completed successfully. Upon authentication of the user to the service, the service can communicate with a backend service(s) of an organization that deployed the service to obtain identity-based policies that are applicable to the user based on their identity, to communicate telemetry data uniquely attributable to the user for analysis by the organization, and/or other use cases.

In implementations, the organization may apply a particular configuration to a secure web browser executing on the user's device before the authentication service can be executed on the device as described in reference to FIGS. 3 and 4. For instance, this may be a configuration necessitated by the web browser for installation of the authentication service. In these cases, the authentication service may derive the configuration from a file or registry key that was previously distributed to/installed on the device. As another example, as part of installation of the authentication service (e.g., as described in reference to FIG. 2), an indication of the organization or user identity can be included in the software package that is downloaded for installation, which can be leveraged to retrieve a basic configuration before full installation of the authentication service. Other implementations of the authentication service can download this initial configuration from a reconfigured server prior to user authentication, where this server can be local or remote. Lastly, the authentication service may derive the initial configuration from a previous version of the authentication service that was installed on the device.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

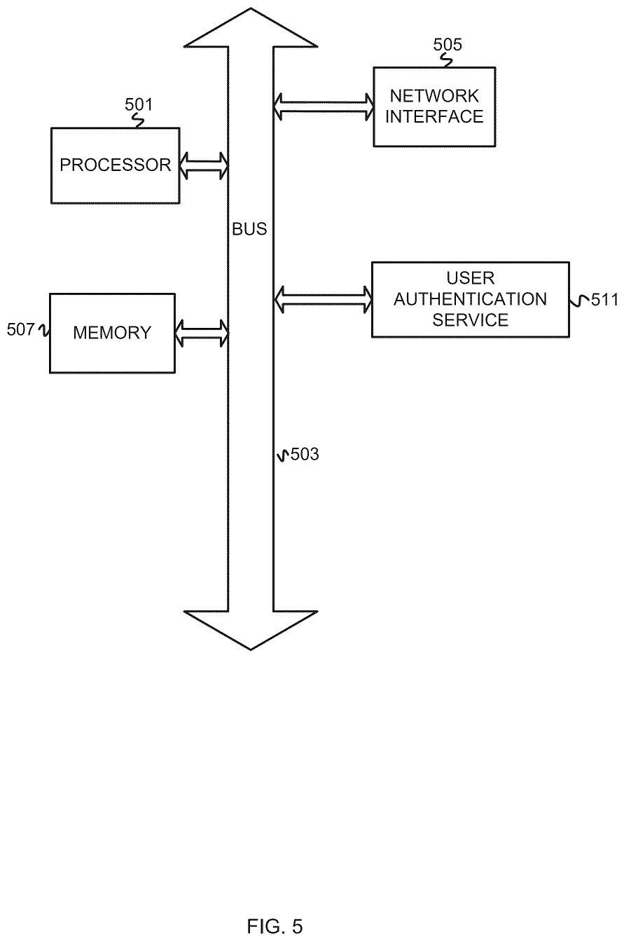

FIG. 5 depicts an example computer system with a user authentication service. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes user authentication service 511. The user authentication service 511 authenticates a user to an agent, browser extension, or other service deployed for MDM that executes on a device issued to the user. The user authentication service 511 authenticates the user with strong authentication without involving the user by determining session information for a session with an identity provider during which the user was strongly authenticated (e.g., as part of SSO) and sending an additional authentication request as part of that session with passive authentication, no prompt authentication, etc. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
authenticating a user with strong authentication to a first service with headless authentication, wherein authenticating the user comprises,
determining an identity of the user based on determining that the user has logged into an account with a service provider, wherein determining the identity of the user is based at least partly on an identity provider used by the service provider;
determining that the user has been authenticated by the identity provider based on determining that a first session with the identity provider has been created for the user; and
sending a modified authentication request to the identity provider as part of the first session to authenticate the user to the first service, wherein the modified authentication request comprises a parameter value that is for configuring authentication without user involvement.

2. The method of claim 1 further comprising generating the modified authentication request based at least partly on a communication protocol or standard used by the identity provider, and wherein generating the modified authentication request comprises generating an authentication request and modifying the authentication request with the parameter value, wherein the parameter value comprises a first parameter value specifying passive authentication or with a second parameter value specifying no prompt.

3. The method of claim 1, wherein determining that the user has logged into the service provider comprises determining that the user has logged into a single sign-on (SSO) service.

4. The method of claim 1, wherein determining that the first session with the identity provider has been created comprises determining that at least one of a first cookie and session information corresponding to the first session has been stored on a device for which the first session was created.

5. The method of claim 1, further comprising determining if an age of the first session satisfies a freshness criterion, wherein sending the modified authentication request is based on determining that the age of the first session satisfies the freshness criterion.

6. The method of claim 1, wherein determining the identity of the user comprises determining a username of the user.

7. The method of claim 1, wherein authenticating the user to the first service comprises authenticating the user to a browser extension or an agent.

8. The method of claim 1, further comprising obtaining configuration data that identifies the identity provider and a user principal name (UPN) suffix and verifying that the identity of the user indicates the UPN suffix indicated in the configuration data, wherein sending the modified authentication request is based on verifying that the identity of the user indicates the UPN suffix.

9. One or more non-transitory machine-readable media having program code stored thereon, the program code comprising instructions to:
determine an identity of a user that has logged into an account with a service provider based at least partly on an identity provider used by the service provider;
based on a determination that a first session with the identity provider has been created for the user, determine that the user has been authenticated by the identity provider; and
authenticate the user to a first service without involvement of the user, wherein the instructions to authenticate the user to the first service without involvement of the user comprise instructions to send an authentication request comprising a parameter value for configuring authentication without user involvement to the identity provider as part of the first session.

10. The non-transitory machine-readable media of claim 9, wherein the program code further comprises instructions to generate the authentication request based at least partly on a communication protocol or standard used by the identity provider, and wherein the parameter value comprises a first parameter value specifying passive authentication or a second parameter value specifying no prompt.

11. The non-transitory machine-readable media of claim 9, wherein the instructions to determine that the first session has been created comprise instructions to determine that at least one of a first cookie and session information corresponding to the first session has been stored on a device for which the first session was created.

12. The non-transitory machine-readable media of claim 9, wherein the program code further comprises instructions to determine whether an age of the first session is below a threshold, wherein the instructions to authenticate the user comprise instructions to authenticate the user based on a determination that the age of the first session is below the threshold.

13. The non-transitory machine-readable media of claim 9, wherein the instructions to determine the identity of the user comprise instruction to determine a username of the user.

14. The non-transitory machine-readable media of claim 13, wherein the program code further comprises instructions to verify that the username of the user indicates a first user principal name (UPN) suffix specified in configuration data that was previously obtained, and wherein the instructions to authenticate the user to the first service comprise instructions to authenticate the user based on verification that the username indicates the first UPN suffix.

15. An apparatus comprising:
a processor; and
a machine-readable medium having instructions stored thereon that are executable by the processor to cause the apparatus to,
identify a user that has logged into an account with a service provider based at least partly on an identity provider used by the service provider;
determine that a first session with the identity provider has been created for the user and that the user has been authenticated by the identity provider; and
authenticate the user to a first service without involvement of the user, wherein the instructions to authenticate the user to the first service without involvement of the user comprise instructions to send an authentication request that comprises a first value specifying authentication without user involvement to the identity provider as part of the first session.

16. The apparatus of claim 15, further comprising instructions executable by the processor to cause the apparatus to generate the authentication request based at least partly on a communication protocol or standard used by the identity provider.

17. The apparatus of claim 16, wherein the instructions executable by the processor to cause the apparatus to generate the authentication request comprise instructions executable by the processor to cause the apparatus to include the first value in the authentication request as a parameter value, wherein the first value specifies passive authentication or authentication with no prompt.

18. The apparatus of claim 15, wherein the instructions executable by the processor to cause the apparatus to determine that the first session has been created comprise instructions executable by the processor to cause the apparatus to determine that at least one of a first cookie and session information corresponding to the first session have been stored.

19. The apparatus of claim 15, wherein the instructions executable by the processor to cause the apparatus to authenticate the user to a first service comprise instructions executable by the processor to cause the apparatus to authenticate to a browser extension or an agent.

20. The apparatus of claim 15, wherein the instructions executable by the processor to cause the apparatus to identify the user comprise instructions executable by the processor to cause the apparatus to determine a username of the user.
